(19) United States
(12) Patent Application Publication
(10) Pub. No.: US 2015/0206442 A1
(43) Pub. Date: Jul. 23, 2015

(54) STUDENT-SPECIFIC ADAPTIVE PERSONALIZED BOOK CREATION

(71) Applicant: Stephen J. Brown, Woodside, CA (US)

(72) Inventor: Stephen J. Brown, Woodside, CA (US)

(73) Assignee: Invent.ly LLC, Woodside, CA (US)

(21) Appl. No.: 14/158,825

(22) Filed: Jan. 18, 2014

(51) Int. Cl. G09B 5/02; G06Q 50/20; G06Q 30/06

(52) U.S. Cl. CPC G09B 5/02; G06Q 30/0621; G06Q 50/20

(57) ABSTRACT

A system and method for creation and/or publication of student-specific adaptive personalized content and/or textbook to enable and provide an efficient learning environment to each based on the student's profile. A student's profile is created based on factors such as learning style, prerequisite knowledge, personality, interests, previous learning experiences, demographic and psychological, among other parameters. The student's profile is processed with respect to a learning object repository to generate a defined set of student-specific learning objects that best suit the profile of the student. A textbook and/or course content can accordingly be generated based on the defined set of student-specific learning objects. Such student-specific textbooks and/or course content can also be adapted/modified in real-time based on changes in the student profile and/or learning object repository.

### TECHNICAL FIELD

The embodiments herein generally relate to customized book creation for students, and more particularly to the creation and/or publication of a student-specific adaptive and personalized course book.

### BACKGROUND

The background description includes information that may be useful in understanding the embodiments herein. It is not an admission that any of the information provided herein is prior art or relevant to the presently claimed embodiments, or that any publication specifically or implicitly referenced is prior art.

Presently, certain educational technology services have been proposed and some implemented to provide teachers, principals, administrators, and other education professionals with tools for teaching skills and materials to students. Some of these tools are software programs that allow student-level interaction and, hence, incorporate instructions that can identify and target weaknesses of a group of students in understanding a topic or mastering a skill set. Although such group-based learning can be helpful to the concerned group of students needing special attention, a major focus of the teaching experience is currently on developing a useful and effective curriculum for the majority of students.

Intelligent learning systems are systems that attempt to assist students in achieving specific learning goals. To date, these systems have mainly used a computerized teaching approach that minors the approach taken in brick-and-mortar classrooms. Each student is presented with the same lecture, content, and assessment, regardless of his/her learning style, intelligence, or cognitive characteristics. Even though such content is generated based on varied sources such as prescribed books, teacher developed content, case studies, supplemental notes, third-party content, among other sources, once created remains stagnant for all students and therefore fails to incorporate factors such as the student's profile, interests, demographic and psychographic attributes, previous performances, among other factors, making the content for few learners difficult to perceive and, for few others, making it too easy to comprehend and hence not resulting into a desired learning experience.

There is therefore a need for creation and/or publication of student-specific adaptive personalized content and/or textbooks that allow students/learners to be presented with textbooks that match their interests, learning style, personality traits, previous knowledge, among other factors.

All publications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

In some embodiments, the numbers expressing quantities of ingredients, properties such as concentration, reaction conditions, and so forth, used to describe and claim certain embodiments herein are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments herein are approximations, the numerical values set forth in the specific examples are reported as precisely as practicable. The numerical values presented in some embodiments herein may contain certain errors necessarily resulting from the standard deviation found in their respective testing measurements.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the descriptions of the embodiments herein and does not pose a limitation on the scope of the embodiments herein otherwise claimed. No language in the specification should be construed as indicating any non-claimed element essential to the practice of the embodiments herein.

Groupings of alternative elements or embodiments herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

### SUMMARY

In view of the foregoing, the embodiments herein provide a technique for the creation and/or publication of student-specific adaptive personalized content and/or textbooks to enable and provide an efficient learning environment to each student based on a respective profile. One aspect of the embodiments herein provides a system and method for enabling creation of a student's profile based on factors such as learning style, prerequisite knowledge, personality, interests, previous learning experiences, demographic and psychological, among other parameters, and processing the student's profile with respect to a learning object repository to generate a defined set of student-specific learning objects that best suit the profile of the student. A textbook and/or course content can accordingly be generated based on the defined set of student-specific learning objects. Such student-specific textbooks and/or course content can also be adapted/modified in real-time based on changes in the student profile and/or learning object repository.

In one aspect, a method comprises generating a student's profile vector of a student based on attributes representative of one or a combination of student's demographic profile, psychographic profile, learning style, interests, prerequisite knowledge assessments, social profile, skill, and performance. In an implementation, a student profile vector can include one or more of the attributes along with values thereof for the student.

The method further comprises retrieving a learning objects matrix based on one or more learning objectives of at least one course, wherein each learning objective can include a plurality of learning objects. Each learning object can be represented by means of a vector of one or more of the above mentioned or additional attributes along with weights thereof. Therefore, each course can have, for example, ‘N’ learning objectives, with each learning objective having M learning objects, making a total of N*M learning objects, such that each learning object can be represented by a vector having ‘S’ attributes (along with a weight of each attribute) that can be common with the attributes that form the student profile vector.

According to one embodiment herein, the generated student profile vector can be processed with the learning objects matrix for the one or more learning objectives to generate a student-specific list of learning objects, wherein the student-specific list of learning objects is generated based on values of attributes for the student and weights of corresponding attributes of the learning objects of the learning objects matrix. The student-specific list of learning objects can then be evaluated to prioritize the list of learning objects. According to another embodiment, a prioritized list of learning objects can be further processed in order to generate a personalized course book for the respective student. Such a course book can either be a textbook or an electronic book, or can be in any other desired format.

In another aspect of the embodiments herein, processing of a student profile vector with a learning objects matrix can include multiplying the value of each attribute of the student profile vector with the weight of a corresponding attribute of learning objects of the learning objects matrix to retrieve the student-specific list of learning objects by selecting a defined number of learning objects after the processing based on an importance value of each learning object for the respective student.

The personalized course book can also be changed/adapted/modified in real-time based on changes in one or more of a student profile vector and the learning objects matrix, wherein the learning objects can be obtained based on one or a combination of core course material, supplemental content, examples, questions, teacher-authored material, curated material, existing literature, student feedback, third-party content, dynamically retrieved stakeholder content, and publisher material.

Another aspect of the embodiments herein provides a system configured to generate personalized course content for a student, wherein the system includes a student profile vector generation module configured to generate a student profile vector of the student based on attributes representative of one or a combination of a student's demographic profile, psychographic profile, learning style, interests, prerequisite knowledge assessments, social profile, skill, and performance. In an implementation, the student vector can include one or more attributes along with weights thereof for the student.

The system can further include a learning object matrix creation module configured to create a learning objects matrix based on one or more learning objectives of at least one course and further based on learning objects of the one or more learning objectives. In an implementation, each learning object can be represented by means of one or more attributes along with weights thereof for the respective learning object in context.

The system can further include a processing module configured to process the student profile vector with the learning objects matrix to generate a student-specific list of learning objects relevant to the student such that a course content generation module of the system can generate a personalized course content for the student based on the generated student-specific list of learning objects. In an implementation, the student-specific list of learning objects can be generated based on values of the attributes of the student and the weights of attributes of the learning objects of the learning objects matrix.

A system and method of generating a personalized course book, the method comprising: generating an electronically represented student profile vector of a student based on attributes representative of one or a combination of a demographic profile, psychographic profile, learning style, interests, prerequisite knowledge assessments, social profile, skill, and performance of the student, wherein the student profile vector comprises one or more of the attributes along with associated quantitative values thereof for the student; generating an electronically represented learning objects matrix based on one or more learning objectives of at least one course, wherein each learning objective comprises a plurality of learning objects, and wherein each learning object comprises an electronically represented vector of one or more of the attributes along with weights thereof; processing the student profile vector with the learning objects matrix for the one or more learning objectives to generate an electronically represented student-specific list of learning objects, wherein the student-specific list of learning objects is generated based on values of attributes of the student and weights of corresponding attributes of the learning objects of the learning objects matrix; evaluating the student-specific list of learning objects to select a set of final learning objects from the student-specific list of learning objects; assembling the final list of learning objects; and generating the personalized course book for the student based on the assembled final list of learning objects.

The processing of the student profile vector with the learning objects matrix comprises multiplying a value of each attribute of the student profile vector with the weight of each corresponding attribute of learning objects of the learning objects matrix to retrieve the student-specific list of learning objects. The method further comprises changing the personalized course book in real-time based on changes in one or more of the student profile vector and the learning objects matrix. The method further comprises continuously updating the weights of attributes of learning objects for matching between vectors of the learning objects and the student profile vector. The method further comprises: monitoring usage of the personalized course book; monitoring results of a particular student meeting a defined learning objective; using the monitored usage and results to adjust the weights of attributes of learning objects; and determining a best fit learning object for the particular student based on the adjusted weights. The weight of each attribute for the learning object is based on a relevance of the attribute for the learning object. The assembling of the final list of learning objects comprises processing a subset of the final list of learning objects. The method further comprises obtaining the learning objects based on one or a combination of core course material, supplemental content, examples, questions, teacher-authored material, curated material, existing literature, student feedback, third-party content, dynamically retrieved stakeholder content, and publisher material. The method further comprises identifying the learning objectives based on relevance of tasks in a current course, tasks in a previous courses, performance of one or more students in the courses, and interest of one or more students in the courses. The method further comprises sorting the student-specific list of learning objects to obtain the final list of learning objects.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1 shows an exemplary computing architecture of the personalized course content generation system in accordance with an embodiment herein;

FIG. 2 is a schematic diagram showing generation of student-specific course content in accordance with an embodiment of the embodiments herein;

FIG. 3 illustrates exemplary functional modules configured to implement generation of student-specific course content in accordance with an embodiment herein;

FIG. 4a illustrates exemplary factors based on which student profile vector can be generated in accordance with an embodiment herein;

FIG. 4b shows the formation of exemplary student profile vectors in accordance with an embodiment herein;

FIG. 5 illustrates generation of a learning object vector in accordance with an embodiment herein;

FIG. 6 illustrates a hierarchical representation of a course repository in accordance with an embodiment herein;

FIG. 7 shows an exemplary illustration of processing a student profile vector with one or more learning objects of a learning objective in accordance with an embodiment herein;

FIG. 8 illustrates an exemplary method for generation of a personalized course book in accordance with an embodiment herein; and

FIG. 9 illustrates a computer system used in accordance with an embodiment herein.

### DETAILED DESCRIPTION

Throughout the following discussion, numerous references will be made regarding servers, services, interfaces, engines, modules, clients, peers, portals, platforms, or other systems formed from computing devices. It should be appreciated that the use of such terms is deemed to represent one or more computing devices having at least one processor (e.g., ASIC, FPGA, DSP, x86, ARM®, ColdFire®, GPU, etc.) configured to execute software instructions stored on a computer readable tangible, non-transitory medium (e.g., hard drive, solid state drive, RAM, flash, ROM, etc.). For example, a server can include one or more computers operating as a web server, database server, or other type of computer server in a manner to fulfill described roles, responsibilities, or functions. One should further appreciate the disclosed computer-based algorithms, processes, methods, or other types of instruction sets can be embodied as a computer program product comprising a non-transitory, tangible computer readable media storing the instructions that cause a processor to execute the disclosed steps. The various servers, systems, databases, or interfaces can exchange data using standardized protocols or algorithms, possibly based on HTTP, HTTPS, AES, public-private key exchanges, web service APIs, known financial transaction protocols, or other electronic information exchanging methods. Data exchanges can be conducted over a packet-switched network, the Internet, LAN, WAN, VPN, or other type of packet switched network.

One should appreciate that the disclosed techniques provide many advantageous technical effects including configuring and processing various feeds to determine behavior, interaction, management, and response of users with respect to feeds and implement outcome in enhancing overall user experience while delivering feed content and allied parameters/attributes thereof.

The following discussion provides many example embodiments. Although each embodiment represents a single combination of inventive elements, the embodiments herein are considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly described.

The embodiments herein relate to the creation and/or publication of student-specific adaptive personalized content and/or textbook to enable and provide an efficient learning environment to each student based on the respective profile. One aspect of the embodiments herein provides a system and method for enabling creation of a student's profile based on factors such as learning style, prerequisite knowledge, personality, interests, previous learning experiences, demographic and psychological, among other parameters, and processing the student's profile with respect to a learning object repository in order to generate a set of student-specific learning objects that best suit the profile of the student. A textbook and/or course content can accordingly be generated based on the set of student-specific learning objects. Such student-specific textbooks and/or course content can also be adapted/modified in real-time based on changes in student profile and/or learning object repository.

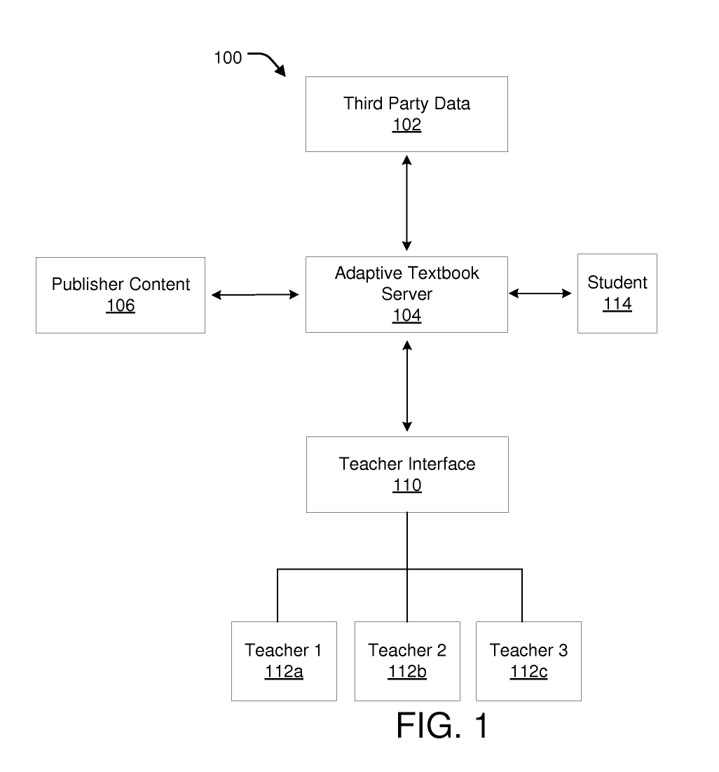

FIG. 1 shows an exemplary computing architecture of the personalized course content generation system 100 in accordance with an embodiment herein. In one aspect of the embodiments herein, system 100 comprises multiple content sources, including, but not limited to, third-party data 102, publisher content 106, and content supplied by one or more teachers 112a, 112b, 112c through teacher interface(s) 110, among other known sources. One should appreciate that any other conceivable source such as student generated content, industry generated content, social media created content, among others are within the scope of the embodiments herein. At the same time, content, hereinafter also interchangeably referred to as data, not only includes course content, but can also include case studies, metadata, assessments, information objects, skills hierarchy data, survey data, course learning objectives, student data/interests/preferences/past results/performance, among other content from many data sources. One should appreciate that although the embodiments herein describe course content or educational content, any other data or format/type thereof, which may or may not be in the education domain, is within the scope of the embodiments herein. One should also appreciate that although the embodiments herein may describe certain aspects with respect to a single course, the content of the embodiments herein can include multiple courses, each having one or more learning tasks/objectives.

According to one embodiment, system 100 includes an adaptive textbook server 104, also referred to as server 104 hereinafter, operatively coupled with one or more content sources such as 102, 106, and 110 and configured to store and process aggregate content. In one aspect, server 104 can either be a single computing device or a group of devices operatively coupled with each other. Content retrieved and/or received from multiple sources can either be stored in a single server or distributed across devices or alternatively stored at a remote data storage device. In an aspect, content received from multiple data sources can be categorized, periodically or dynamically, and then aggregated based on the course/subject to which the content pertains.

According to another embodiment, from a hierarchical standpoint, content stored in and/or accessible to server 104 can include multiple courses, each course having one or more learning tasks, also interchangeably referred to as learning objectives hereinafter. Each learning objective can further include a plurality of learning objects, which collectively form the respective learning objective. In an aspect of the embodiments herein, each learning object can be represented by means of a vector having one or more attributes with each attribute having a weight associated thereto. Such attributes can include student profile attributes such as learning style related attributes, interests related attributes, preferences related attributes, personality related attributes, among other attributes. Weights to such attributes can be allocated based on how relevant a given attribute is to the learning object in context. For example, for learning objects of a practical learning objective, such as, for example, “analytical chemistry”, “case-studies” based learning style attributes may have higher weights when compared with theory based on learning style attributes.

In another aspect of the embodiments herein, server 104 can be configured to form a learning objects matrix based on one or more learning objectives of at least one course. Learning objects matrix can therefore be a m*n dimensional matrix, having ‘n’ learning tasks/objectives with each objective having ‘m’ learning objects, thereby making a repository of learning objects for a given course. In another aspect, a given learning objects matrix can also be configured to represent multiple courses or parts thereof based on the learning tasks to be included as part of the matrix.

In another embodiment of the embodiments herein, the adaptive textbook server 104 can be configured to receive and/or generate a student profile vector of a student 114 based on attributes representative of one or a combination of a student's demographic profile, psychographic profile, learning style, interests, prerequisite knowledge assessments, social profile, skill, and performance, wherein the student profile vector is represented by means of one or more of the attributes along with values thereof for the respective student 114. According to one embodiment, the student profile vector can have the same dimensionality as the vectors of learning objects, wherein both the student profile vector and the vectors of learning objects can have the same set of attributes. For example, for each attribute based on which the learning objects are identified, a value can be associated based on the students' profile, personality, performance, course interaction, learning style, interests, preferences, among other parameters and factors. The student profile vector can then be formed by aggregating attributes and values thereof.

In another embodiment, server 104 can be configured to process a student profile vector of a given student 114 with learning objects matrix for one or more learning objectives to generate a student-specific list of learning objects, wherein the student-specific list of learning objects is generated based on values of attributes of the student profile vector and weights of corresponding attributes of the learning object vectors of the learning objects matrix. In an implementation, the student profile vector can be multiplied with one or more learning object vectors of respective learning objects of a plurality of learning objectives in order to compute importance values of each learning object for the student 114 in context, based on which a textbook or e-book or a book in any other format can then be created by the server 104 using the student-specific list of learning objects or a part thereof.

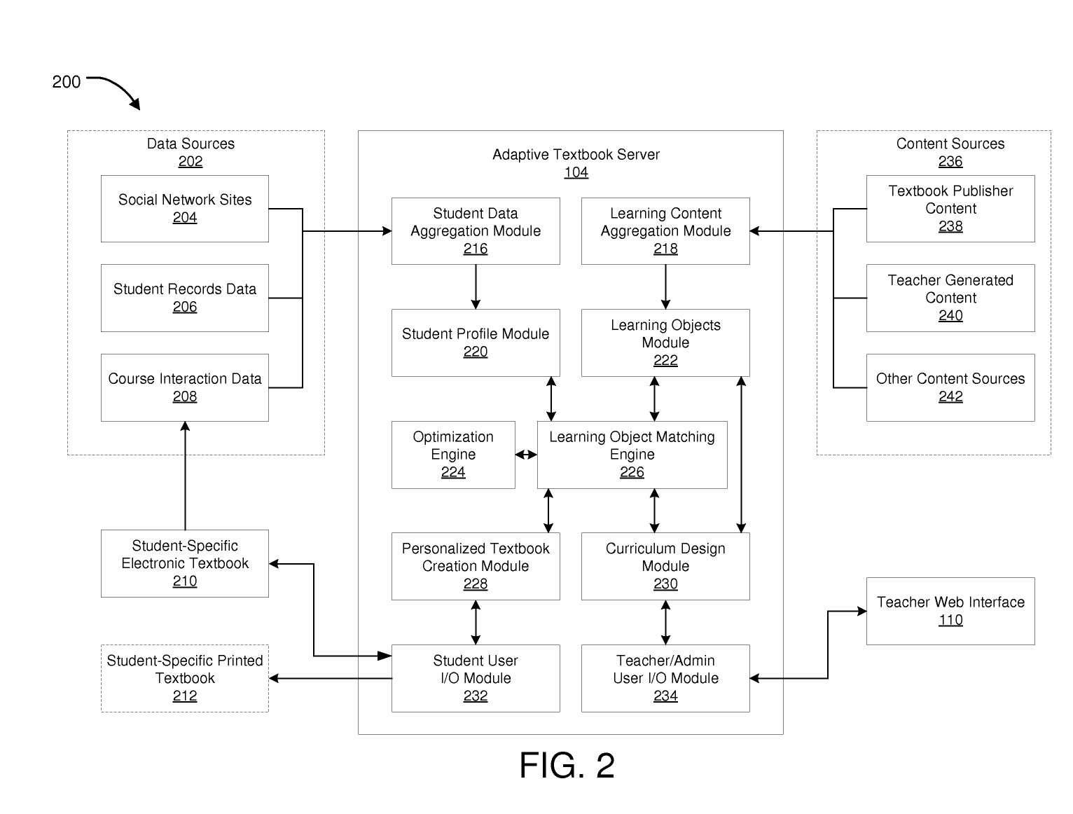

FIG. 2, with reference to FIG. 1, is a schematic diagram of a system 200 showing generation of student-specific course content in accordance with an embodiment herein. System 200 comprises the adaptive textbook server 104 operatively coupled with content sources 236 and data sources 202, wherein content sources 236 include course content provided by multiple stakeholders including, but not limited to, publishers, third-parties, teachers, students, among other entities. In one aspect, content sources 236 can include textbook publisher content 238, teacher generated content 240, and other content sources 242. Such content, as also mentioned above, not only includes actual course material and chapters therein, but also includes assessments, case-studies, metadata, examples, practical scenario's, samples, among others. In an example, teacher generated content 240 can include standard text, supplemental material, instructor authored material, among other content that the concerned faculty is involved in for creation, review, amendments, and publication. Other content sources 242 can also include dynamically changing data, including but not limited to, student notes, student attention data, student quiz performance results, instructor annotations, instructor private notes, and exam results, among other such course material.

Data sources 202, on the other hand, can be configured to include data generated by means of student interaction and/or feedback such as data from social network sites/interactions 204, student records 206, and course interaction 208. One should appreciate that any other student specific data reflective of demographic profile, interests, learning styles, prerequisite knowledge, skills, preferences, psychographic profiles, previous test scores, among other desired information can be included as part of the data sources 202. In an implementation, such data sources 202 can also be aggregated along with content from sources 236 to form comprehensive course material, which can be then be processed based on student profile to generate student-specific textbooks 210, 212.

According to one embodiment, server 104 can include a student data aggregation module 216 configured to aggregate student-specific information from data sources 202 in order to generate profiles for one or more students 114, wherein such profiles can be stored in student profile module 220. In an implementation, each student profile can be represented by means of a student profile vector that comprises one or more attributes reflective of traits, prerequisite knowledge, learning style, personality, interests, social interactions, preferences, social profile, among other student-level parameters. Each vector can be configured to have a defined number of attributes, which have values associated thereto based on their relevance for the student/user in context. For example, for a student X, his preferences may indicate more learning efficiency through video-based content when compared with audio-based content, and therefore video-based attributes may have higher values for the respective student 114 when compared with values for audio-based attributes.

According to another embodiment, server 104 can include a learning content aggregation module 218 configured to aggregate content relating to one or more courses from multiple content sources 236 and generate a learning objects module 222. Such a learning objects module 222, as explained with reference to FIG. 1, can include a plurality of learning objects, wherein each educational course can include one or more learning objectives, and each learning objective/task can include one or more learning objects, thereby leading to formation of the plurality of learning objects. According to one embodiment, each learning object can be represented by means of a vector, referred to as learning object vector hereinafter, of attributes along with weights thereof, wherein such attributes are selected from the set of attributes based on which student profile vectors are generated. In an exemplary implementation, dimensionality of each learning object is the same as that of the student vector, enabling efficient processing of each learning object of each learning objective/task of each course with respect to the student profile vector.

According to another embodiment, server 104 includes a learning object matching engine 226 that is operatively coupled with student profile module 220 and learning objects module 222 and is configured to process the profile vector of a given student, for example S1, with respect to one or more learning object vectors of at least one course in order to compute and associate an importance value with the one or more respective learning objects. In an implementation, such learning objects, by means of their respective importance values, can be processed and/or optimized through an optimization engine 224 in order to, for example, prioritize the learning objects or select a subset of learning objects. According to an embodiment, such a subset of learning objects can then, by means of a personalized textbook creation module 228 of the server 104, enable generation of a textbook 212 or an e-book 210 or any other formatted course book. According to another embodiment, prioritized list of learning objects can also be used by a curriculum design module 230 to modify, append, amend, revise, and/or create the course curriculum so as to make it as specific to the student profile(s) as possible, thereby enhancing the learning experience and overall grasp of course content.

In an aspect of the embodiments herein, server 104 can include a student I/O interface module 232 configured to send/share/enable reading of the published student-specific electronic textbook 210 and/or student-specific printed textbook 212 by the respective student 114. In an implementation, a given student-specific textbook 210 can be modified at run-time based on changes in learning objects module 222 and/or student profile module 220. In another aspect of the embodiments herein, server 104 can further include a teacher/administrator/user I/O interface module 234 configured to enable a teacher 112a-112c (of FIG. 1) or any other relevant stakeholder to view, amend, and/or change the course curriculum through teacher web interface 110. One should appreciate that system 200 of FIG. 2 can be automated, semi-automated, or can be executed manually in order to generate personalized textbooks/e-books 210, 212 based on student profile vectors, and at the same time, enable designing of course curriculum based on processing of student profile vector with one or more learning object vectors to make the course structure accurate and apt for the learning of all students at large.

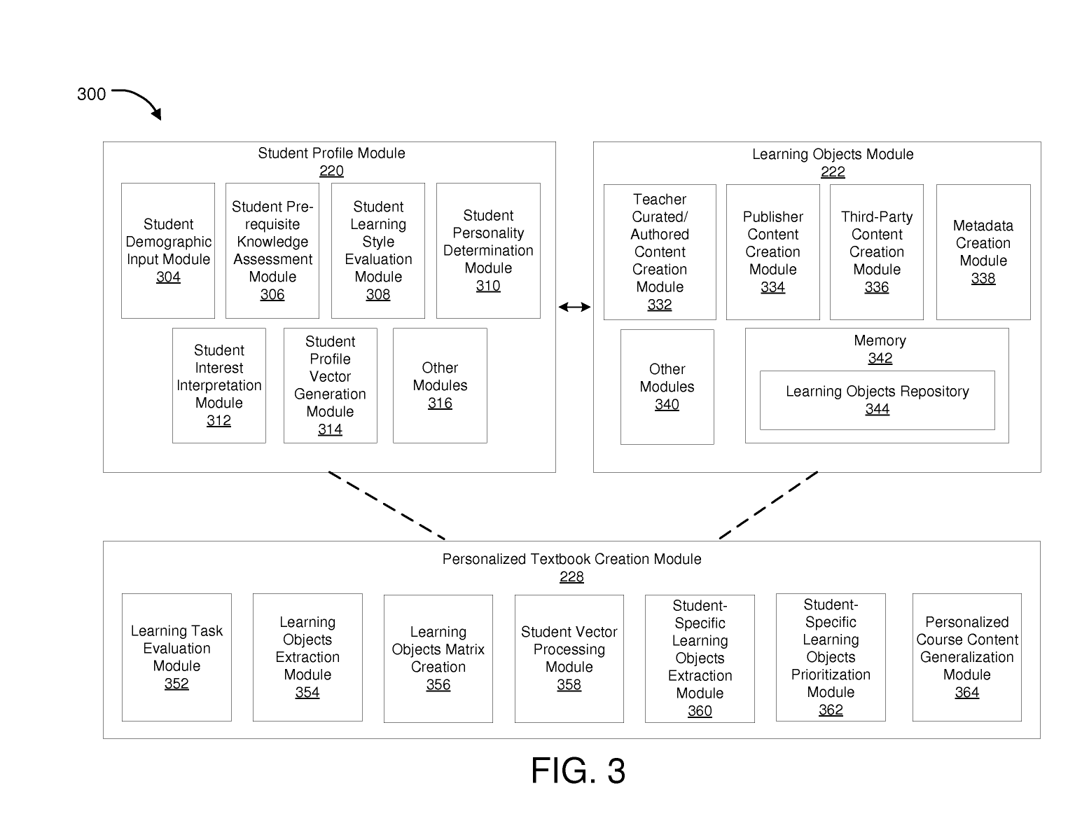

FIG. 3, with reference to FIGS. 1 through 2, illustrates exemplary functional modules 300 configured to implement generation of student-specific course content in accordance with an embodiment herein. In an exemplary embodiment, functional modules 300 can include the student profile module 220, the learning objects module 222, and the personalized textbook creation module 228, which are operatively coupled with each other and can be implemented on a single computing device or a combination of different devices that are remotely connected with each other. Moreover, the specific modules associated with each of the modules 220, 222, 228 (e.g., modules 304-316 associated with the student profile module 220; modules 332-344 associated with the learning objects module 222; and modules 352-364 associated with the personalized textbook creation module 228) are respectively operably coupled with each other and can be implemented on a single computing device or a combination of different devices that are remotely connected with each other.

According to one embodiment, student profile module 220 can be configured to generate a student profile vector for at least one student 114 based on student attributes such as profile, interests, social interactions, preferences, learning styles, among other attributes that can define the learning pattern and what and how the student 114 may be more inclined to study efficiently for improvement in performance. In an exemplary embodiment, module 220 can further comprise modules including, but not limited to, student demographic input module 304, student prerequisite knowledge assessment module 306, student learning style evaluation module 308, student personality determination module 310, student interest interpretation module 312, student profile vector generation module 314, among other modules 316 that can be configured to incorporate multiple attributes (or types thereof) of a plurality of students 114 and associate values to one or more attributes based on the student profile in order to form a student profile vector.

According to one embodiment, student demographic input module 304 can be configured to incorporate a list of demographic attributes in which one or more students 114 in context can be assessed/profiled. Demographic attributes can include, but are not limited to, age, gender, generation, race, ethnicity, education background, qualifications, geographic region, marital status, among other attributes. Upon generation of a list of demographic attributes, module 304 can be configured to evaluate each student 114 on one or more attributes and associate a value based on the same. In an embodiment, one or more demographic attributes can be combined to form a defined number of common attributes, values of each of which can then be associated for each student 114. For example, students 114 with a weaker academic background can be associated with a higher/lower value for attribute A in order to indicate a stronger need to learn certain courses (or learning objectives within a given course).

According to another embodiment, student prerequisite knowledge assessment module 306 can be configured to evaluate prerequisite knowledge of one or more students 114 in order to associate attributes based on the prerequisite knowledge assessment to reflect courses of importance for each student 114 along with indicating the past performance and understanding level of the student 114 with respect to various learning objectives/tasks and learning objects. Prerequisite knowledge with respect to one or more learning objectives for a given student 114 can also help identify and correlate values of various attributes associated with the past performance and knowledge/learning level of the student 114. For example, for a learning objective such as polynomials, based on the previous performance and current knowledge level of student 1 and student 2, different values can be coupled with attributes of the prerequisite knowledge for each student 114.

According to another embodiment, student learning style evaluation module 308 can be configured to evaluate learning styles of one or more students 114 in order to associate attributes based on the learning styles and habits of the students 114 so as to identify the mode of teaching, such as case-based, concrete experience based, abstract conceptualization based, discovery based, hands-on and concert based, theoretical, practical exercises based, among others, in which the student 114 would be most efficient. The learning style for a student 114 relates to one's natural or habitual pattern of acquiring and processing information in learning situations. As different models have been proposed for evaluating learning styles of students 114 such as David Kolb's model, Peter Honey and Alan Mumford's model, among others, any or a combination these models can be used to evaluate each student 114 and identify a common set of attributes for all students 114 so that values can be associated to such attributes based on the learning styles prevalent with each student 114.

According to an implementation, the learning style for one or more students 114 can be evaluated based on their measure on attributes relating to four groups, namely, accomodators, converger, diverger, and assimilator. One should appreciate that each student 114 can have a combination of two or more of the above mentioned categories, wherein accomodators typically relate to users who believe in concrete experience and active experiments, whereas convergers focus more on abstract conceptualization and active experiments, and divergers relate more to concrete experience and reflective observation based on learning, and assimilators are more apt to abstract conceptualization and reflective observation based knowledge enhancement. Any other model can also be used, independently or combined with other known models, to define one or more learning style based attributes, and value each student 114 based on such defined learning style based attributes.

According to another embodiment, student personality determination module 310 can be configured to evaluate personality and traits related attributes of each student 114 in order to associate values to such attributes for each student 114 based on behavioral traits, social traits, attitude related attributes, ability/skills related attributes, temperament/energy/responsibility/initiative/leadership/punctuality related attributes. Personality attributes can play a significant role in determining the type, mode, and kind of content that the student 114 would like to receive and efficiently process for desired learning. Student interests interpretation module 312, on the other hand, can be configured to identify interests, preferences, and hobbies for each student 114 and process such interest-based data to associate values with attributes that define such interests at a common level for one or more students 114. According to one embodiment, social interactions, social networking patterns, friends circle, type of network connections, type of videos viewed, daily routine, among other factors can help define interests and personality attributes of one or more students 114, which can then be evaluated based on a set of defined attributes by associating values with each attribute of the set.

According to one embodiment, student profile vector generation module 314 can be configured to generate a student profile vector of a student 114 based on attributes representative of one or a combination of a student's demographic profile, psychographic profile, learning style, interests, prerequisite knowledge assessments, social profile, skill, performance, among other parameters/factors defined by other student profile indicating module 316, wherein the student profile vector can include a defined set of attributes along with values thereof for the given student 114. In an example, student profile vector for a student S₁ can include a defined set of, for example six attributes (A₁ to A₆), which may or may not be common across other students S₂ to Sₙ, wherein each of the six attributes for any given student can have a defined value; e.g., V₁ to V₆, which collectively are indicative of the student's profile. Similarly, the second student, S₂, can have different values associated with the same attributes (A₁ to A₆). In an implementation, a second student can also have a different set of attributes or additional attributes along with values thereof for the second student, based on which a different student profile vector can be generated.

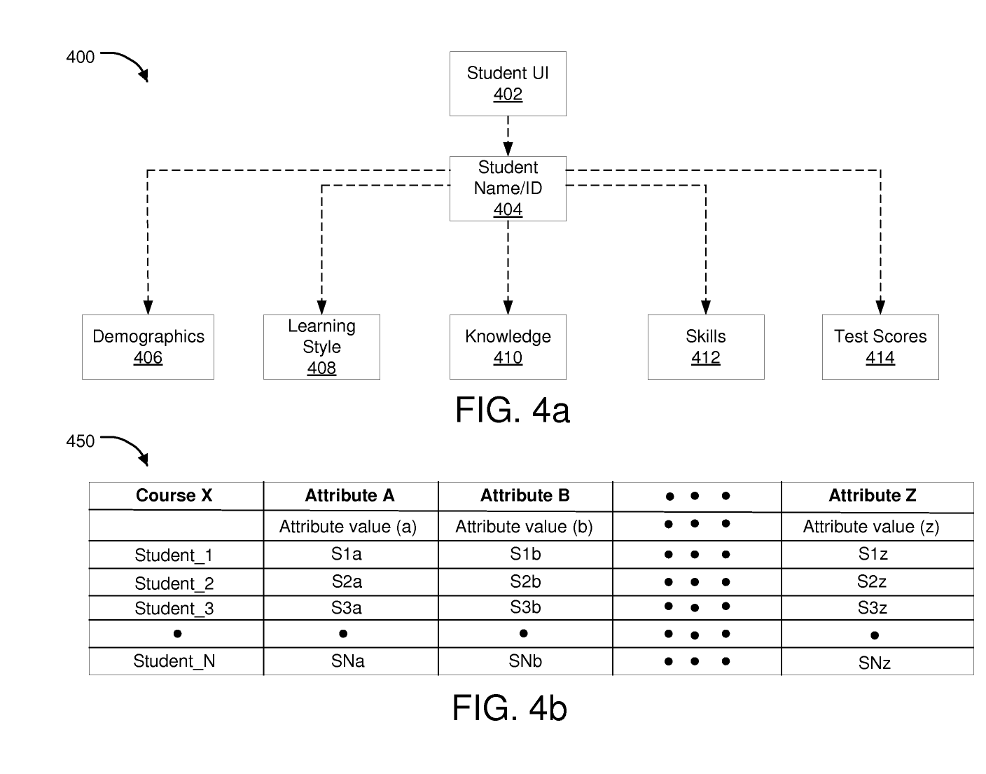

FIG. 4a, with reference to FIGS. 1 through 3, illustrates a factoring system 400 used to generate a student profile vector in accordance with an embodiment herein. As can be seen, the system 400 can include a student user interface (UI) 402 by means of which one or more students 114 can interact with the system 400 to share feedback, content, annotations, preferences, along with submitting their profile attributes across different evaluation parameters in order to enable values to be associated with one or more student-specific attributes. Each student 114, also referred to as a user or learner in accordance with the embodiments herein, can be identified through his/her name or an identifier 404 or a combination thereof, wherein each student 114 can be associated with a common or different set of attributes including demographic attributes 406, learning style based attributes 408, prerequisite or current knowledge based attributes 410, skills based attributes 412, and past test scores based attributes 414, values for which can be computed for each student 114 to generate a student profile vector.

In an example, test scores 414 can be used to determine the characteristics/attribute values of a student 114, wherein in order to assess/quantify such attributes, a testing application can be executed on the student's UI 402 using an executable software provided on a CD-ROM, flash drive, or any other storage or transmission mechanism including wireless transmission means. The student 114 can respond to questions generated by the testing application, and the responses can be used to determine scores for individual or groups of questions. In another such operating mode, the student 114 may have previously taken a standardized test, results of which can be provided based on the graded standardized test. In some other embodiments, student UI 402 can be presented by means of a third-party computer (not shown) that is operatively coupled to the Internet over a communication link (not shown).

In a similar implementation, learning style 408 can be used as a parameter for quantifying attributes that relate to the learning style of a given student 114. Learning styles, in an embodiment herein, can be evaluated by means of a number of Boolean indicators used to signify whether or not a student 114 is related to one of a corresponding number of standard learning styles such as physical, interpersonal, intrapersonal, linguistic, mathematical, musical, and visual. Learning style approaches can also be evaluated based on, for example, whether the approach is instructional based, reference based, drill and practice based, exploration and discovery based, tools based, or education game based. Such students 114 can then be rated/valued for one or more attributes that correspond to learning styles, wherein the values can be from, for example, 1 (worst) to 5 (best). Such ratings can also be categorized as education value based, fun based, ease of use based, depth/reusability based, reviewer's opinion based, among other applicable categories.

FIG. 4b, with reference to FIGS. 1 through 4a, shows the formation of exemplary student profile vectors 450 in accordance with an embodiment herein. In accordance with FIG. 4b, each student, for example Student_1, Student_2, Student_3, . . . , Student_N, can be coupled with a corresponding student profile vector, for example SV_1, SV_2, SV_3, . . . , SV_N, wherein a given student profile vector SV can be generated by aggregating a set of common attributes across students along with values of each attribute for the student in context. For example, with reference to FIG. 4b, the vector for each student can be created based on attributes A, B, . . . , Z, wherein the value for each attribute can be different for each student based on the student's profile, learning style, social interactions, preferences, among other above defined parameters/characteristics. In an example, student profile vector SV_1 for Student_1 can be represented as SV_1={S1a, S1b, . . . , S1z}, wherein S1a is the value of attribute A for student S1, S1b is the value of attribute B for student S1, and S1z is the value of attribute Z for student S1. Vectors can similarly be computed for one or more students and appropriately stored.

According to one embodiment, learning objects module 222 can be configured to create a repository 344 of learning objects that can be stored in a memory 342 of the system 300. The memory 342 can either be internal to the system/server 104 or can be located remotely for being accessed by one or more servers. In an embodiment, repository 344 can be configured to store learning objects for one or more courses, wherein each course can include at least one learning objective/task and each learning objective/task can be defined by means of a plurality of learning objects. According to one embodiment, module 222 can include one or more of a teacher curated/authored content creation module 332, publisher content creation module 334, third-party content creation module 336, metadata creation module 338, among other modules 340 that are configured to create, modify, review, amend, collate, and aggregate course content from multiple sources such as teachers, third parties, publishers, students, industry, among other stakeholders. According to one embodiment, learning objects can be organized in a hierarchy that is based on the skills associated with the learning objects. The learning objects can also be made to compete with one another for a spot in the hierarchy so that the “best” learning object can be recommended more often. Learning object, in addition to representing course content, can also include one or a combination of metadata, case studies, practical examples, exercises, assessments, relationships with other learning objects of a given learning objective, skills hierarchy data, information objects, among other type or cast of content.

According to one embodiment, each learning object can be represented by means of a vector having a defined set of attributes having weights associated with each attribute based on the learning object in context. In an implementation, the number of attributes based on which student profile vectors are generated can be the same as the number of attributes based on which each learning object vector is instantiated. For example, in case a student profile vector is represented through four attributes such as interests, learning style, prerequisite knowledge, and skills; the same set of four attributes can be used for representation of the learning object vector as well, wherein weights can be associated with each attribute of the learning object vector based on the learning object in reference.

Again with reference to FIG. 3, personalized textbook creation module 228 can be configured to generate a student specific course book 210, 212 based on the student profile vector and one or more learning objects. According to one embodiment, module 228 can include a learning task evaluation module 352, a learning objects extraction module 354, a learning objects matrix creation module 356, a student vector processing module 358, a student-specific learning objects extraction module 360, a student-specific learning objects prioritization module 362, and a personalized course content generalization module 364, one or more of which are operatively coupled with each other to assist in generation of personalized course content based on student profile vector(s) and learning object(s).

According to one embodiment, learning task evaluation module 352 can be configured to evaluate the course and learning objectives that a student 114 wishes to undergo as part of a curriculum or even otherwise. Once a course is chosen by a student 114 or is expected to be taken by the student 114, one or more learning objectives that form part of the selected course can be retrieved and then evaluated to select the final set of learning objectives that may be most relevant for the student 114. Such evaluation can either be performed automatically based on student profile, prerequisite knowledge, previous courses taken, among other factors.

According to one embodiment, learning objects extraction module 354 can be configured to, for each selected learning objected, retrieve and/or extract all learning objects that form part of the learning objective. In an alternate embodiment, only a specific type of learning objects can be extracted for further analysis and generation student-specific course book. Such a course book can include a book in any desired format including, but not limited to, a physical textbook 212 and electronic book (e-book) 210.

According to another embodiment, the learning objects matrix creation module 356 can be configured to create a matrix of learning objects for one or more learning objectives. In an implementation, the matrix of learning objects can be created independently for each learning objective, wherein each learning object of the learning objective can be configured as a row of the matrix and attributes of the learning objects can be configured as columns. Alternatively, learning objects of multiple learning objectives, and even multiple courses or a combination thereof, can be presented in a single learning objects matrix, wherein each matrix represents one or more learning objects along with weights of each attribute by which the learning objects are defined. In another implementation, the learning objects matrix creation module 356 can always be executed and/or performed in any sequence of the system 300, which is even before the learning objects of a chosen course/learning objectives are extracted by module 354 or even before a given learning objective/course is selected by module 352.

According to another embodiment, student vector processing module 358 can be configured to process the student profile vector of a given student 114 with the learning objects matrix created in module 356 for one or more learning objectives evaluated in module 352 in order to generate a student-specific list of learning objects, wherein the student-specific list of learning objects can be generated based on values of attributes of the student profile vector, and weights of corresponding attributes of the learning objects of the learning objects matrix. In an exemplary implementation therefore, as the dimensionality of each learning object is the same as that of the student profile vector of a given student 114, the learning object vector can be multiplied (e.g., processed) with the student profile vector so as to enable multiplication of each attribute value of the respective student 114 with the weight associated to a corresponding attribute for the learning object in context.

The output of such multiplication can reflect the importance of each processed learning object for the respective student 114, which can help prioritize the output list of learning objects and use one or more of the more relevant learning objects to create the student specific course book 210, 212. Student-specific learning objects extraction module 360 can then be configured to extract the student-specific learning objects from the output of module 358. In an implementation, such student-specific learning objects can be a subset of learning objects that are chosen based on the output value achieved from the processing between the student profile vector and each learning object vector. For example, the subset of learning objects can be defined as the top half (e.g., ≧50%) of the total number of learning objects in the matrix under consideration such that the top half reflects the highest output values (after processing) as regards to the relevancy of the learning objects for the student 114 in context. Similarly, instead of a percentage, only the top five most relevant learning objects can be extracted by the module 360. In another alternate embodiment, all learning objects can be extracted along with their respective output values achieved from multiplication of student attribute values with learning object attribute weights.

In an implementation, instead of multiplying vectors of all learning objects in the learning objects matrix with a student profile vector, only a defined number of learning objects can be selected from the objects matrix based on one or more criteria, and then multiplied with the student profile vector to generate a list of student-specific learning objects.

According to one embodiment, student-specific learning objects prioritization module 362 can be configured to prioritize one or more learning objects extracted by module 360 so as to sort the learning objects in order of their relevancy for the student 114 in context. It should be appreciated that module 362 can also be implemented as a sub-module of objects extraction module 360. Prioritization module 362 can therefore enable sorting or any other form of processing of the student-specific learning objects in order to obtain a defined number of learning objects, based on which the course book 210, 212 can be created. Therefore, on one end, all ranked student-specific learning objects can be prioritized and used accordingly for creation of the course book 210, 212, and, on another end, only the top and most relevant learning object can be used for creation of the course book 210, 212.

According to one embodiment, personalized course content generalization module 364 can be configured to incorporate and process a defined number of the most relevant learning objects and use the same for generation of the personalized course content. For example, the top three learning objects can be identified as being the most relevant for a student 114, and can then be processed such that the personalized course book 210, 212 for the student 114 in context focuses primarily on the final three learning objects. Therefore, although the student-specific course book 210, 212 can include modules/chapter/text relating to other learning objects as well, the primary focus of the book 210, 212 can be generated on the most relevant set of learning objects, which does not only relate to course content, but also the manner of giving instructions, focus on case-studies, number of hours required for completing the respective course/learning objective, need for practical experiments, among other parameters.

In an embodiment, the student personalized course book 210, 212 can also be coupled with student-specific problem sets and quizzes, which can be delivered automatically based on the student-specific learning objects generated subsequent to processing with student profile vector, wherein the course book 210, 212 can also be accompanied with supplemental material such as flash cards and annotations.

In another embodiment, the personalized course book 210, 212 can also be adapted/updated automatically based on changes in student profile vector(s) and/or learning object vector(s) such that the proposed module 364 or another separate module can continuously and automatically monitor changes in the student 114 profile/preferences/interests/learning styles and modify the student-specific learning objects based on such changes, thereby ensuring that the personalized course book 210, 212 is continuously improved and kept accurate with the student's progress or change in applicable attributes. Course books 210, 212 can also be printed or delivered on demand so that all the individualized course content can be in one place rather than scattered among books and binders of supplemental materials.

In an embodiment, as results of the students 114 are accumulated and updated over a period of time, attributes, based on which student profile vector and learning object vectors are formed, can also be updated in terms of their values and weights respectively. System 300 can therefore be configured to dynamically adapt and modify weights associated with various attributes of learning objects in order to keep the representation of learning objects accurate with respect to the learning objective to which it belongs. In an implementation, the learning object vector weights can be adapted such that the updated weights represent actual performance data over a large population of students 114. Adapted textbooks 210, 212 can then be delivered on the run to the students 114 through a physical or electronic medium. In another implementation, attention and performance data of students 114 can be used to change/modify/refine weights associated with attributes of learning objects. For example, parameters such as time and attention on a given learning object/objective, sequence through learning objects, usage and choices of supplemental materials, gaps in interaction indicating off-task behavior, patterns on quizzes, repeated hint requests, among other parameters can be used to modify the weights associated with the attributes of learning objects. In yet another implementation, additional contextual data can be collected to further refine the attribute weights, wherein such additional contextual data can include, but is not limited to, additional student profile data, data on other courses currently being attempted by the student(s) 114, data/time of usage, location of student's home and school, among other contextual factors.

In another exemplary embodiment, teachers and/or publishers can also be allowed to modify personalized course books 210, 212 once they are generated for each student 114 so as to review and make them more relevant and streamlined with student's additional attributes that may or may not have been taken into consideration while forming the student profile vector. In other words, by looking at the results of many students 114 with many profiles, the optimization on the learning object data can be performed by adjusting the weights associated with the attributes of learning objects such that the best performing learning objects for a given personality vector are chosen. Additionally, with individual teachers continuing to add their own knowledge to the creation of content, new and better performing content modules can emerge.

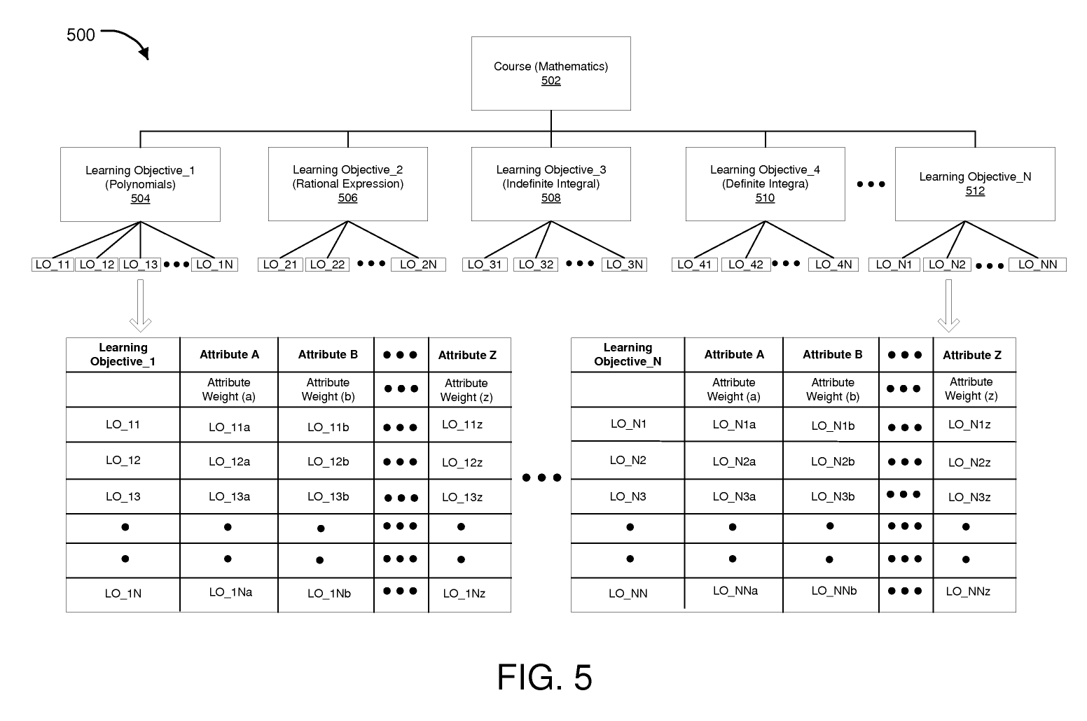

FIG. 5, with reference to FIGS. 1 through 4b, illustrates the generation of a learning object vector 500 in accordance with an embodiment herein. As shown, a given course 502, such as mathematics, can include multiple learning objectives such as learning objective_1 (polynomials) 504, learning objective_2 (rational expression) 506, learning objective_3 (indefinite integral) 508, learning objective_4 (definite integra) 510, . . . , and learning objective_N 512. Each course ‘x’ can therefore be expressed as a series of ‘n’ learning tasks, wherein x={x1, x2, x3, . . . , xn}, where each of x1, x2, x3, . . . , xn represents a learning objective/task. In an implementation, ideal score of the course can be computed as a sum of ideal score of xi, i.e., sum(ideal_score(xi)). Each learning task xi may require a defined prerequisite knowledge ‘p’, represented by p={p1, p2, . . . , pn}.

In an embodiment, each learning objective/task xi can include one or more learning objects. In an exemplary implementation, learning task xi can have m learning objects oi, wherein oi={o1, o2, o3, . . . , om}. Assuming each learning task xi of a given course A has ‘m’ learning objects and that there are ‘n’ learning tasks, the total number of learning objects, which can be represented as a learning objects matrix O would be of the dimensions n*m for the respective course. For example, learning objective_1 can include four learning objects LO_11, LO_12, LO_13, and LO_1N. Similarly, learning objective_2 can include multiple learning objects such as LO_21, LO_22, . . . , LO_2N. Each learning objective can therefore include a different or same number of learning objects based on the course structure, logical modules in each course, possible case-studies involved, number of possible assessments, among other parameters.

According to one embodiment, the number of learning objectives of a given course B to be considered for processing with respect to student profile can also be defined based on aggregate number of tasks in the course B (x), number of tasks (y) of current course B that were already taught properly in previous course, B−1 for example, and number of tasks (z) of that were part of the previous course B−1 but were not appropriately covered. In such a situation, the total number of tasks to be covered can include x+z−y. Any other characteristic indicative of prerequisite gap, new content, and tasks that have been mastered can also be incorporated while deciding the total number of tasks/learning objectives to be covered by the student(s) 114 in context. In an alternative embodiment, it is to be noted that mastered prerequisite knowledge or mastered learning tasks may still be included in the text, subject to how the thresholds for defining learning tasks are set.

According to one embodiment, each learning object can be represented by means of a vector having a defined set of attributes having weights associated with each attribute based on the learning object in context. In an implementation, the number of attributes based on which student profile vectors are generated can be the same as the number of attributes based on which each learning object vector is instantiated. For example, in case a student profile vector is represented through four attributes such as interests, learning style, prerequisite knowledge, and skills; the same set of four attributes can be used for representation of the learning object vector as well, wherein weights can be associated with each attribute of the learning object vector based on the learning object in reference.

A matrix of N*Z can been generated for each learning objective such as Learning Objective_1, wherein each learning object (LO_11, LO_12, LO_13, . . . , LO_1N) of the Learning Objective_1 can be represented through a combination of Z attributes (A-Z), with each attribute being associated with a weight based on the learning object in context. For example, learning object LO_11 can be a vector represented by {LO_11a, LO_11b, LO_11c, . . . , LO_11z}, wherein LO_11a represents the weight of attribute A for learning object LO_11a and LO_11b represents the weight of attribute B for learning object LO_11. Similar vectors can then also be formed for each learning object of Learning Objective_1. In an implementation, each learning objective can accordingly be processed for each course so as to generate a unique vector that represents each learning object.

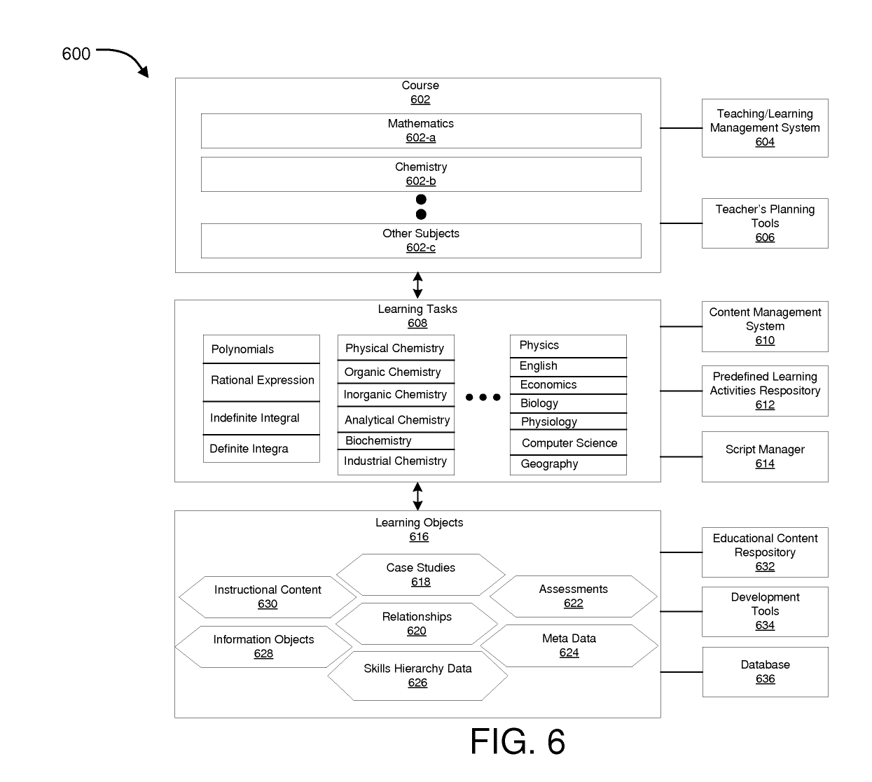

FIG. 6, with reference to FIGS. 1 through 5, illustrates a hierarchical representation of a course repository 600 in accordance with an embodiment herein. As indicated, the course repository 600 can include one or more courses 602 such as, for example, mathematics 602-a, chemistry 602-b, among and other subjects 602-c to 602-n, which can be designed, modified, created, and brought to curriculum based on teaching/learning management systems 604 and one or more planning tools 606. In an implementation, one or more courses 602 can be generated and managed by the system 604, which may create and/or store the courses 602. For example, a browser interface (e.g., teacher interface 110 of FIG. 1) can allow a teacher 112a-112c (of FIG. 1) to browse through learning activities (e.g., sorted or filtered by subject, difficulty level, time length, or other properties), and to select and construct a course by combining one or more learning activities (e.g., using a drag-and-drop interface, a time-line, or other tools). Additionally or alternatively, predefined lessons may be available for utilization by teachers through third-parties and publishers.

Each course 602 can include one or more learning tasks or activities or objectives 608, wherein for example, a course of mathematics 602-a can include learning objectives such as polynomials, rational expressions, indefinite integral, definite integra, among others. In an exemplary implementation, learning objectives can be managed by means of one or a combination of content management system 610, predefined learning activity repository 612, and script manager 614. According to one embodiment, learning tasks 608 can be generated and managed by the content management system 610, which may create and/or store the learning objectives. Predefined learning activity repository 612, on the other hand, can be configured to store predefined learning activities, which can be utilized by teachers 112a-112c and other stakeholders for editing/modification/layout/presentation of the content to the students/users/learners 114. The script manager 614, on the other hand, may be used to create, modify and/or store scripts which define the components of the learning activity, their order or sequence, an associated time-line, and associated properties (e.g., requirements, conditions, or the like). Optionally, scripts may include rules or scripting commands that allow dynamic modification of the learning activity based on various conditions or contexts, for example, based on past performance of the particular student 114 that uses the learning activity, based on preferences of the particular student 114 that uses the learning activity, based on the phase of the learning process, or the like. Optionally, the script may be part of the teaching/learning plan. Once activated or executed, the script calls the appropriate learning object(s) from the educational content repository 632, and may optionally assign them to students 114; e.g., differentially or adaptively. The script may be implemented, for example, using Educational Modeling Language (EML), using scripting methods and commands in accordance with IMS Learning Design (LD) specifications and standards, or the like. In some embodiments, the script manager 614 may include an EML editor, thereby integrating EML editing functions into the teaching/learning system 604. In some embodiments, the teaching/learning system and/or the script manager 614 utilize a “modeling language” and/or “scripting language” that use pedagogic terms; e.g., describing pedagogic events and pedagogic activities with which teachers 112a-112c are familiar. The script may further include specifications as to what type of data should be stored or reported to the teacher 112a-112c substantially in real time, for example, with regard to students' interactions or responses to a learning object. For example, the script may indicate to the teaching/learning system 604 to automatically perform one or more of these operations: to store all the results and/or answers provided by students 114 to all the questions, or to a selected group of questions; to store all the choices made by the student 114, or only the student's last choice; to report in real time to the teacher 112a-112c if predefined conditions are true, e.g., if at least 50% of the answers of a student 114 are wrong, etc.

According to another embodiment, each learning task 608 can include one or more learning objects 616, wherein each learning object 616 can be representative of one or a combination of case studies 618, relationships 620, assessments 622, metadata 624, skills hierarchy data 626, information objects 628, and instructional content 630, among other types of different data. In an embodiment, a learning object 616 for a given learning objective, for example geometry, can be referenced by a learning object identifier, and associated data or references to the associated data may be stored in a relational database such as database 636, and may reference the identifier to indicate that the data is associated with the learning object represented by the identifier.

From another perspective, learning content may be aggregated using a number of learning objects arranged at different aggregation levels, wherein each higher-level learning object may refer to any learning object at a lower level. At its lowest level, a learning object can correspond to content and is not further divisible. In an implementation, course material can be include four types of learning objects: a course, a sub-course, a learning unit, and a knowledge item. Starting from the lowest level, knowledge items are the basis for the other learning objects and are the building blocks of the course content structure. Such knowledge items can be stored in repository 632 along with other types of learning objects Each knowledge item may include content that illustrates, explains, practices, or tests an aspect of a thematic area or topic. Knowledge items typically are small in size (i.e., of short duration, e.g., approximately five minutes or less). Attributes may be used to describe a knowledge item, such as, for example, a name, a type of media, and a type of knowledge. Learning units may be assembled using one or more knowledge items to represent, for example, a distinct, thematically-coherent unit. Consequently, learning units may be considered containers for knowledge items of the same general topic. Learning units also may be relatively small in size (i.e., small in duration) though larger than a knowledge item. Sub-courses may be assembled using other sub-courses, learning units, and/or knowledge items. A given sub-course may be used to split up an extensive course into several smaller subordinate courses. Sub-courses may be used to build an arbitrarily deep nested structure by referring to other sub-courses. Courses may be assembled from all of the subordinate learning objects including sub-courses, learning units, and knowledge items. To foster maximum reuse, all learning objects may be self-contained and context free.

Learning objects 616 may be tagged with metadata that is used to support adaptive delivery, reusability, and search/retrieval of content associated with the learning objects. For example, learning objective metadata (LOM) defined by the IEEE “Learning Object Metadata Working Group” may be attached to individual learning objects. A learning objective can be treated as information that is to be imparted by an electronic course, or a subset thereof, to a user taking the electronic course. Learning objective metadata noted above may represent numerical identifiers that correspond to learning objectives. The metadata may be used to configure an electronic course based on whether a user has met learning objectives associated with learning object(s) that make up the course. Other metadata can identify the “version” of the object 616 using an identifier, such as a number. Object versions and their use are described in more detail below. Still other metadata may relate to a number of knowledge types (e.g., orientation, action, explanation, and resources) that may be used to categorize learning objects.

In another embodiment, each learning object 616 can include content including, by way of example and not by way of limitation, assessments, remediation data, skills hierarchy data, bloom level data, learning object metadata, and object-specific personalized data, wherein the content is said to be “included” as part of a learning object, even though the content may only be referenced by the learning object, but may not actually be stored within a learning object data structure. Content may be stored in a educational content repository 632 and managed by one or more development tools 634. In an embodiment, the content can be “tagged” with metadata describing the content, such as keywords, skills, associated learning objects, the types of learners (e.g. visual) that may benefit from the content, the type of content (e.g. video or text), and statistical information regarding the content usage.

In an implementation, each learning object 616 can be represented as a vector of a set of attributes, each attribute being associated with a weight for the concerned learning object in context. In an embodiment, number of attributes in each vector of a learning object can be same as the number of attributes can represent any given student profile vector. In an alternate embodiment, the number of attributes in each learning object can be different, and can also be different from the number attributes that are configured to define student profile vector(s).

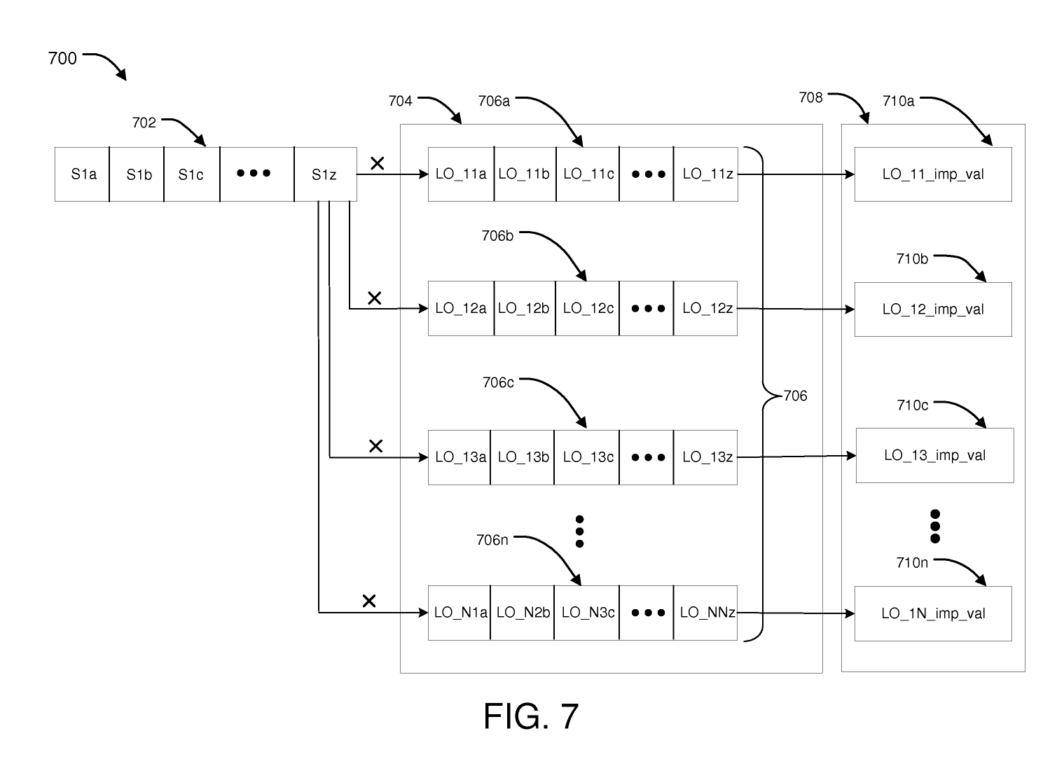

FIG. 7, with reference to FIGS. 1 through 6, depicts an exemplary illustration 700 of processing a student profile vector 702 with one or more learning objects 706 of a learning objective 704. As indicated in FIG. 7, a given student profile vector 702 can be processed with multiple learning objects 706a, 706b, 706c, . . . , 706n, collectively referred to as learning objects 706 hereinafter, of a given learning objects matrix. Although the example implementation in FIG. 7 depicts a learning objects matrix being created for each learning objective 704, it should be appreciated that the matrix can represent any number of learning objectives and/or courses. Furthermore, although the example implementation of FIG. 7 depicts the processing of each learning object of the matrix with the student profile vector 702, it should be appreciated that even a subset of learning objects can be selected from the matrix for multiplication with the student profile vector 702.

A given student profile vector 702 can be multiplied with each learning object vector 706 such that value of each attribute of student profile vector 702 can be multiplied with the weight of the corresponding attribute of the respective learning object 706. For example, S1a can be multiplied with LO_11a, S1b can be multiplied with LO_11b, and so on, to generate aggregate values of each attribute for the respective student 114, which can then be summed to generate the importance value (LO_11_imp_val) 710-a of the respective learning object LO_11 for the given student 114 in context. In an example implementation, LO_11_imp_val 710-a represents the importance value of learning object LO_11 for student S1, which can be computed as LO_11_imp_val={S1a*LO_11a+S1b*LO_11b+S1c*LO_11c+ . . . +S1z*LO_11z}. Similarly, the mportance values (such as LO_12_imp_val, LO_13_imp_val, LO_14_imp_val, . . . , LO_1N_imp_val) for each learning object 706 can be computed with respect to the student profile vector 702 to generate a list 708 of ‘learning object importance values’.

In an example implementation, once the importance values, also referred to as ‘relevance’ hereinafter, for each learning object has been generated with respect to a given student profile vector, one or more of the learning objects, based on their respective relevance for the student 114, can be processed in order to generate the course book/textbook 210, 212. In an example implementation, instructional content along with metadata, case studies, and examples, of a selected set of relevant learning objects can be processed/aggregated to form the course book 210, 212. Such a student-specific course book 210, 212 may then be transmitted to the respective student 114 either physically or electronically.

In an implementation, weights associated with one or more attributes of a learning object can be updated and/or refitted at defined or dynamic intervals based on accumulated results from one or more of feedback from stakeholders on generated student-specific course books, comparisons with defined efficiency/learning thresholds, change in learning pattern/style/traits, among other like factors. Such feedback and comments can be aggregated by means of statistical methods of machine learning such as by using regression analysis to determine weights that should be associated with one or more attributes of a learning object or a group of objects. Aggregation of weights for each attribute of a learning object can then help compute the weight of the learning object as well, making it possible to change weights for one or more learning objects based on their interaction with various stakeholders including students. In an instance, such weights can depict the relevance and/or importance that each attribute holds with respect to concerned learning object, and the relevance that each learning object holds with respect to concerned learning objective. In an implementation, feedback from multiple students and their interaction with respective student-specific course book can be measured and evaluated as part of the aggregated data to help assign and/or dynamically update weights associated with one or more attributes.

In an implementation, in order to compute and assign modified weights to attributes of learning objects, one or a combination of multiple regression techniques can be incorporated to calculate weights that minimize the difference between the predicted set of most relevant learning objects and the actual results obtained based on aggregation. The embodiments herein enable a minimum difference between actual rankings and predicted rankings for relevance of one or more learning objects. A feedback loop can therefore be established to generate student-specific course books and then take feedback from multiple entities and stakeholders relating to efficiency/learning styles/pattern/performance, among other metrics, and accordingly modify weights associated with learning objects and/or attributes thereof to assist in generation of more accurate and knowledge/learning enhancing course materials.

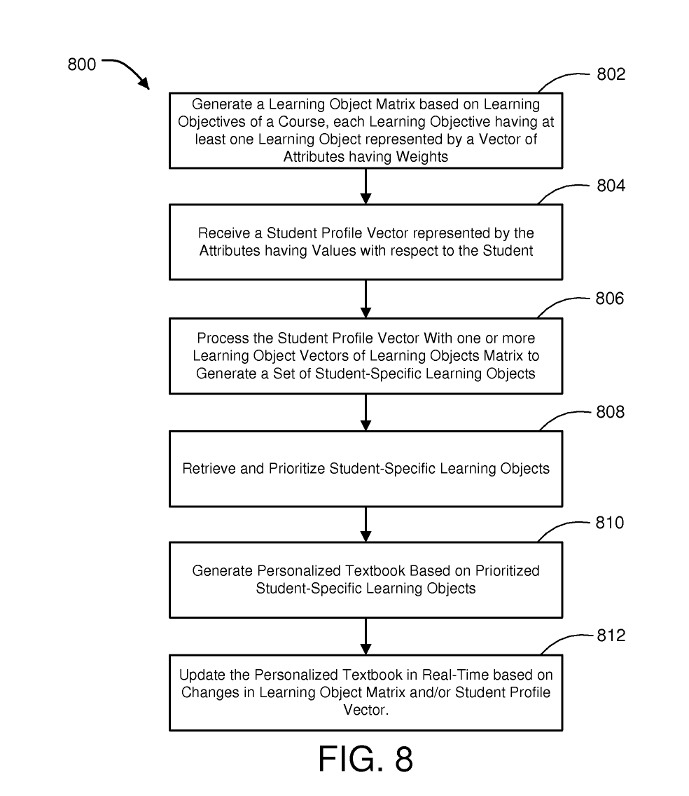

FIG. 8, with reference to FIGS. 1 through 7, illustrates an exemplary method 800 for generation of personalized course book 210, 212 in accordance with an embodiment herein. In step 802, a learning objects matrix can be generated by aggregating a plurality of learning objects of one or more learning objectives of at least one course, wherein each learning objective comprises at least one learning object, and wherein each learning object can be represented as a vector of one or more attributes having weights associated thereto for the respective learning object. Such attributes can relate of multiple learning styles, preferences, interests, learning object characteristics, prerequisite knowledge, among other factors.

At step 804, the student profile vector for a given student 114 can be received, wherein the student profile vector can be generated based on attributes representative of one or a combination of a student's demographic profile, psychographic profile, learning style, interests, prerequisite knowledge assessments, social profile, skill, and performance, and wherein the vector can include one or more of attributes along with values thereof for the student 114 in context. In an example implementation, the attributes based on the student profile vector is defined can be the same or a subset of the attributes based on which one or more learning objects are represented.

At step 806, the student profile vector can be processed with one or more learning objects of the learning objects matrix for the one or more learning objectives to generate a student-specific list of learning objects, wherein the student-specific list of learning objects can be generated based on values of the attributes of the student profile vector and weights of corresponding attributes of the learning objects vectors of the learning objects matrix. In an example implementation, the processing of the student profile vector with the learning objects matrix can include multiplying the value of each attribute of the student profile vector with the weight of each corresponding attribute of learning objects of the learning objects matrix to retrieve the student-specific list of learning objects. In an example embodiment, the student-specific list of learning objects can be a subset of learning objects that form part of the learning objects matrix, wherein the subset is selected based on a defined number of most relevant learning objects. For example, from a list of sixty learning objects that have been processed with respect to the student profile vector, the top ten learning objects having the most relevance for the student 114 in context can be retrieved. In an alternate embodiment, the student-specific list of learning objects can include all learning objects that form part of the learning objects matrix.

At step 808, the student-specific list of learning objects can be retrieved and prioritized in order to obtain a defined number of learning objects based on which the course book 210, 212 can be generated. It should be appreciated that in case step 806 identifies the student-specific list of learning objects as a final subset of learning objects, then step 808 can be avoided. Also, the step of prioritization 808, can include sorting of the learning objects based on their relevancy to the student 114 in context such that the most relevant learning object is on the top of the list of the student-specific list of learning objects. Alternatively, steps 806 and 808 can also be combined with an objective of retrieving a final set of learning objects from the total number of learning objects, wherein the final set defines the student-specific list of learning objects.

At step 810, the student-specific list of learning objects, also interchangeably, referred to as a prioritized set of learning objects, can be processed to generate the personalized textbook/course book 210, 212. At step 812, the generated personalized textbook/course book 210, 212 can be updated/modified in real-time based on a change in the student profile vector and/or one or more learning object vectors. Change(s) in student profile vector can take place by any modification in attributes or values thereof for the student 114 in context, wherein such changes can either be identified in real-time or periodically at defined time intervals. Similarly, changes in learning objects can be identified by detecting any change in attributes that form part of the learning object vector or in weights associated with the attributes.

The embodiments herein can include both hardware and software elements. The embodiments that are implemented in software include but are not limited to, firmware, resident software, microcode, etc. For example, the microcontroller can be configured to run software either stored locally or stored and run from a remote site.

In this regard, the software elements can be stored in the form of a computer program product accessible from a computer-usable or computer-readable medium providing program code for use by or in connection with a computer or any instruction execution system. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium, fixed or removable.

Input/output (I/O) devices (including but not limited to keyboards, displays, pointing devices, etc.) can be coupled to the system either directly or through intervening I/O controllers, wired or wireless. Network adapters may also be coupled to the system to enable the data processing system to become coupled to other data processing systems or remote printers or storage devices through intervening private or public networks.

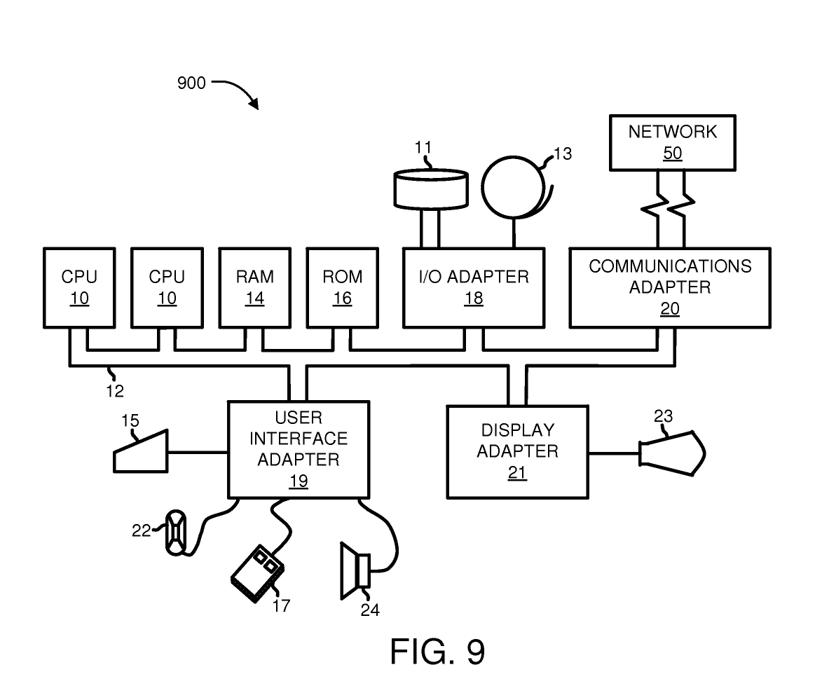

A representative hardware environment for practicing the software embodiments either locally or remotely is depicted in FIG. 9, with reference to FIGS. 1 through 8. This schematic drawing illustrates a hardware configuration of an information handling/computer system 900 in accordance with the embodiments herein. The system 900 comprises at least one processor or central processing unit (CPU) 10. The CPUs 10 are interconnected via system bus 12 to various devices such as a random access memory (RAM) 14, read-only memory (ROM) 16, and an input/output (I/O) adapter 18. The I/O adapter 18 can connect to peripheral devices 11, 13, or other program storage devices that are readable by the system 900. The system 900 can read the inventive instructions on the program storage devices and follow these instructions to execute the methodology of the embodiments herein. The system 900 further includes a user interface adapter 19 that connects a keyboard 15, mouse 17, speaker 24, microphone 22, and/or other user interface devices such as a touch screen device (not shown) to the bus 12 to gather user input. Additionally, a communication adapter 20 connects the bus 12 to a data processing network 25, and a display adapter 21 connects the bus 12 to a display device 23 which may be embodied as an output device such as a monitor, printer, or transmitter, for example.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. Within the context of this document terms “coupled to” and “coupled with” are also used euphemistically to mean “communicatively coupled with” over a network, where two or more devices are able to exchange data with each other over the network, possibly via one or more intermediary device.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc. The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

What is claimed is:

1. A method of generating a personalized course book, said method comprising:
generating an electronically represented student profile vector of a student based on attributes representative of one or a combination of a demographic profile, psychographic profile, learning style, interests, prerequisite knowledge assessments, social profile, skill, and performance of said student, wherein said student profile vector comprises one or more of said attributes along with associated quantitative values thereof for said student;
generating an electronically represented learning objects matrix based on one or more learning objectives of at least one course, wherein each learning objective comprises a plurality of learning objects, and wherein each learning object comprises an electronically represented vector of one or more of said attributes along with weights thereof;
processing said student profile vector with said learning objects matrix for said one or more learning objectives to generate an electronically represented student-specific list of learning objects, wherein said student-specific list of learning objects is generated based on values of attributes of said student and weights of corresponding attributes of said learning objects of said learning objects matrix;
evaluating said student-specific list of learning objects to select a set of final learning objects from said student-specific list of learning objects;
assembling said final list of learning objects; and
generating said personalized course book for said student based on the assembled final list of learning objects.

2. The method of claim 1, wherein the processing of said student profile vector with said learning objects matrix comprises multiplying a value of each attribute of said student profile vector with the weight of each corresponding attribute of learning objects of said learning objects matrix to retrieve said student-specific list of learning objects.

3. The method of claim 1, further comprising changing said personalized course book in real-time based on changes in one or more of said student profile vector and said learning objects matrix.

4. The method of claim 1, further comprising continuously updating the weights of attributes of learning objects for matching between vectors of said learning objects and said student profile vector.

5. The method of claim 4, further comprising:
monitoring usage of said personalized course book;
monitoring results of a particular student meeting a defined learning objective;
using the monitored usage and results to adjust said weights of attributes of learning objects; and
determining a best fit learning object for said particular student based on the adjusted weights.

6. The method of claim 1, wherein the weight of each attribute for said learning object is based on a relevance of said attribute for said learning object.

7. The method of claim 1, wherein the assembling of said final list of learning objects comprises processing a subset of said final list of learning objects.

8. The method of claim 1, further comprising obtaining said learning objects based on one or a combination of core course material, supplemental content, examples, questions, teacher-authored material, curated material, existing literature, student feedback, third-party content, dynamically retrieved stakeholder content, and publisher material.

9. The method of claim 1, further comprising identifying said learning objectives based on relevance of tasks in a current course, tasks in a previous courses, performance of one or more students in said courses, and interest of one or more students in said courses.

10. The method of claim 1, further comprising sorting said student-specific list of learning objects to obtain said final list of learning objects.

11. A system for generating personalized course book for a student, said system comprising:
a computer-implanted database that stores a plurality of learning objects corresponding to one or more learning objectives, wherein said plurality of learning objects are organized based on a learning objects matrix that is representative of one or more learning objectives of at least one course such that each learning objective comprises at least one learning object;
a student profile vector generation module that generates an electronically represented student profile vector of said student based on attributes representative of one or a combination of a demographic profile, psychographic profile, learning style, interests, prerequisite knowledge assessments, social profile, skill, and performance of said student, wherein said student profile vector comprises one or more of said attributes along with quantitative values thereof for said student;
an electronically represented learning object matrix creation module that creates a learning objects matrix based on one or more learning objectives of at least one course, wherein each learning objective comprises a plurality of learning objects, and wherein each learning object comprises an electronically represented vector of one or more of said attributes along with weights thereof;
a processing module that processes said student profile vector with said learning objects matrix for said one or more learning objectives to generate a student-specific list of learning objects, wherein said student-specific list of learning objects is generated based on values of attributes of said student and weights of corresponding attributes of said learning objects of said learning objects matrix;
a prioritization module that prioritizes said student-specific list of learning objects; and
a course content generation module that generates said personalized course book for said student based on said prioritized list of student-specific learning objects.

12. The system of claim 11, wherein said processing module multiplies a value of each attribute of said student profile vector with the weight of each corresponding attribute of learning objects of said learning objects matrix to retrieve said student-specific list of learning objects.

13. The system of claim 11, wherein said personalized course book is changed in real-time based on changes in one or more of said student profile vector and said learning objects matrix.

14. The system of claim 11, wherein each of said respective learning objects is represented as an electronically represented vector of object attributes.

15. The system of claim 11, wherein said learning objects are obtained based on one or a combination of core course material, supplemental content, examples, questions, teacher-authored material, curated material, existing literature, student feedback, third-party content, dynamically retrieved stakeholder content, and publisher material.

16. The system of claim 11, wherein said learning objectives are identified based on relevance of tasks in current course, tasks in previous courses, performance of one or more students in said courses, and interest of one or more students in said courses.

17. The system of claim 11, wherein said prioritization module sorts said student-specific list of learning objects to obtain said prioritized list of learning objects.

18. The system of claim 11, wherein the weights of attributes of learning objects for matching between vectors of said learning objects and said student profile vector are continuously updated using a processor.

19. The system of claim 18, wherein said processor:
monitors usage of said personalized course book;
monitors results of a particular student meeting a defined learning objective;
uses the monitored usage and results to adjust said weights of attributes of learning objects; and
determines a best fit learning object for said particular student based on the adjusted weights.
